(19) United States
(12) Patent Application Publication
(10) Pub. No.: US 2016/0369777 A1
(43) Pub. Date: Dec. 22, 2016

(54) SYSTEM AND METHOD FOR DETECTING ANOMALY CONDITIONS OF SENSOR ATTACHED DEVICES

(71) Applicants: Bigwood Technology, Inc., Ithaca, NY (US); Tianjin University, Tianjin (CN); University of Jinan, Jinan (CN)

(72) Inventors: Hsiao-Dong Chiang, Ithaca, NY (US); Bin Wang, Ithaca, NY (US); Xin-Gong CHENG, Jinan (CN); Yong ZHANG, Jinan (CN)

(21) Appl. No.: 14/729,141

(22) Filed: Jun. 3, 2015

(51) Int. Cl. G21C 17/00; F03D 9/00; H02J 3/38

(52) U.S. Cl. CPC F03D 11/0091; F03D 9/005; H02J 3/386

(57) ABSTRACT

A data monitoring system detects an anomaly condition of a device having attached sensors. The system builds one or more models to establish normal behaviors of the device by analyzing historical sensor data, and apply the models to target sensor data of the device to compute one or more anomaly scores of the device. The system reports the condition of the device based on an analysis of the anomaly scores. To build the one or more models, the system identifies at least one optimization problem for each of the models; constructs a dynamical system such that stable equilibrium points (SEPs) of the dynamical system have one-to-one correspondence with local optimal solutions of the at least one optimization problem; finds the local optimal solutions by computing the SEPs of the dynamical system; and identifies a global optimal solution to the at least one optimization problem among the local optimal solutions.

### TECHNICAL FIELD

Embodiments of the invention relate to anomaly detection in various systems using sensor data.

### BACKGROUND

Sensors are often used in systems, such as power systems, for various purposes. For example, sensors are attached to a wind turbine to take measurements including real-time power outputs, air pressure, air temperature, etc. These measurements are used for monitoring the operating conditions of a power system device. Analyzing the data measured by the sensors and detecting anomalies in the sensor data are the basis for early warning of potential faults of the device.

Anomalies are abnormal and minor patterns emerging in the measurements that distinguish themselves from normal and major patterns. Anomalies can have a variety of lengths, magnitudes, and shapes. In terms of their durations, these anomalies can be broadly classified into two major categories: 1) anomalous points where the measured values at these points are considerably away from normal values, and 2) anomalous intervals where the measured values looks normal if investigated point-wise, while the interval as a whole presents abnormal patterns.

Effective methods are needed for automatically detecting anomalies in the sensor data, especially when many devices in the system need to be monitored simultaneously. Successful methods for anomaly detection rely on accurate models of the system under consideration to capture the discrepancy between the actual sensor measurements and the model outputs, for all possible operating conditions, thus to detect unanticipated events. These methods capture unexpected signatures, and suggest which residuals are normal or which ones resulted from abnormal conditions.

A variety of techniques have been proposed for anomaly detection based on estimation theory, failure sensitive filters, multiple hypothesis filter detection, generalized likelihood ratio tests, model-based approach, statistical analysis, and information theory.

The process of building a system and program for detecting anomalies in the sensor data for monitoring the running conditions of power system devices generally consists of the following stages: 1) the stage of collecting data measured by the sensors attached to the devices and storing the collected data in a database, 2) the stage of exploring the collected data and choosing a proper technique or model to be used for the task, 3) the stage of selecting or computing the best structure of the chosen model, and 4) the stage of determining or computing the best parameters of the chosen model with determined structure, and finally 5) the stage of deploying the built system and program to the power system to monitor the running conditions of the devices.

The relationship between the effectiveness and performance of the chosen model for anomaly detection and its structure and parameters can be complex and generally nonlinear. Therefore, there is a need for an effective technique to improve the performance of anomaly detection in the running conditions of power system devices.

### SUMMARY

According to one embodiment of the invention, a computer-implemented method is provided for detecting an anomaly condition of a device having attached sensors. The method includes: building one or more models to establish normal behaviors of the device by analyzing historical sensor data of the device; applying the one or more models to target sensor data of the device to compute one or more anomaly scores of the device; and reporting a condition of the device based on an analysis of the one or more anomaly scores. Building the one or more models further comprises: identifying at least one optimization problem for each of the models; constructing a dynamical system such that stable equilibrium points (SEPs) of the dynamical system have one-to-one correspondence with local optimal solutions of the at least one optimization problem; finding the local optimal solutions by computing the SEPs of the dynamical system; and identifying a global optimal solution to the at least one optimization problem among the local optimal solutions.

In another embodiment, a system is provided for detecting an anomaly condition of a device having attached sensors. The system includes data storage to store historical sensor data of the device; a data analysis module coupled to the data storage and adapted to: build one or more models to establish normal behaviors of the device by analyzing the historical sensor data, and apply the one or more models to target sensor data of the device to compute one or more anomaly scores of the device; and a condition reporting module coupled to the data storage and adapted to report a condition of the device based on an analysis of the one or more anomaly scores. The data analysis module further includes a model building unit adapted to: identify at least one optimization problem for each of the models; construct a dynamical system such that SEPs of the dynamical system have one-to-one correspondence with local optimal solutions of the at least one optimization problem; find the local optimal solutions by computing the SEPs of the dynamical system; and identify a global optimal solution to the at least one optimization problem among the local optimal solutions.

In yet another embodiment, a non-transitory computer readable storage medium includes instructions that, when executed by a computer system, cause the computer system to perform the aforementioned method for detecting an anomaly condition of a device having attached sensors.

### BRIEF DESCRIPTION OF THE DRAWINGS

Embodiments are illustrated by way of example and not limitation in the Figures of the accompanying drawings:

FIG. 1 illustrates a diagram of the overall architecture of a system for anomaly detection according to one embodiment.

FIG. 2 is a signal waveform diagram illustrating examples of sensor signals and identified anomalies in the signals according to one embodiment.

FIG. 3 illustrates a flow diagram of a method of building models for data analysis according to one embodiment.

FIG. 4 illustrates a flow diagram of a method of computing anomaly scores according to one embodiment.

FIG. 5 illustrates a diagram of an anomaly score computing unit according to one embodiment.

FIG. 6 illustrates a diagram of a model building unit according to one embodiment.

FIG. 7 illustrates a diagram of building and training neural network based predictive models according to one embodiment.

FIG. 8 illustrates a diagram of building and training auto-regression based statistical models according to one embodiment.

FIG. 9 illustrates a diagram of building and training affinity propagation based clustering models according to one embodiment.

FIG. 10 is a signal waveform diagram illustrating examples of sensor signals and anomalies in the detected signals according to one embodiment.

FIG. 11 is a signal waveform diagram illustrating another example of sensor signals and anomalies in the detected signals according to one embodiment.

FIG. 12 is a flow diagram illustrating a method for anomaly detection according to one embodiment.

FIG. 13 is a block diagram illustrating an example of a computer system according to one embodiment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

To realize a system and method of improved performance for detecting anomalies in the sensor data for monitoring the running conditions of a device, it is desirable to incorporate in the process of model building a deterministic optimization method that can not only escape from a local optimal solution, but compute multiple local optimal solutions to the involved optimization problem.

A method, system, apparatus and computer programs encoded on computer storage media, for detecting anomalies in various systems are described herein. Although power system devices are mentioned as examples in the following description, it is understood that embodiments of the invention can be applied to any devices having attached sensors. In one embodiment, the method includes receiving and storing a plurality of measured values from a plurality of sensors monitoring the performance of a power system device. The method includes building a plurality of models to establish normal behaviors of the power plant device by analyzing the plurality of data stored. The models include a predictive model, a clustering model, and a statistical model. The method includes executing the plurality of normal models on the received sensor data to compute scores regarding the condition of the device. The method includes assessing the condition of the device by analyzing the computed scores. The method includes reporting the condition of the device.

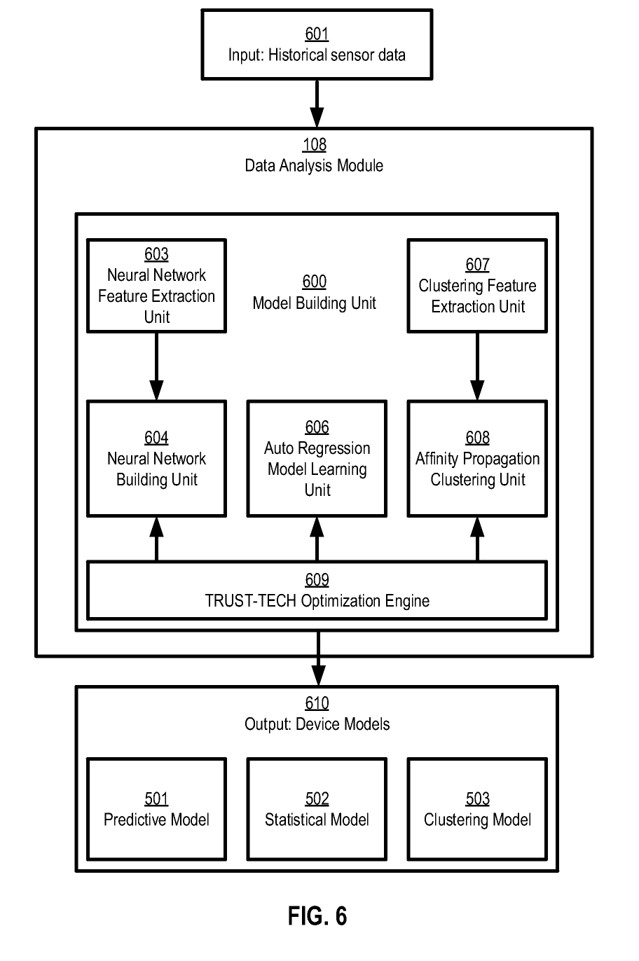

In one embodiment, a plurality of TRUST-TECH enhanced models are built to establish normal behaviors of the power system device by analyzing the plurality of data stored. In one embodiment, the models include a TRUST-TECH enhanced neural network model, a TRUST-TECH enhanced clustering model, and a TRUST-TECH enhanced statistical model. The TRUST-TECH methodology, also referred to as the dynamical trajectory based methodology, has been described in U.S. Pat. No. 7,050,953 and U.S. Pat. No. 7,277,832. Further details of the TRUST-TECH enhanced methods are described below in connection with FIGS. 6-9.

In one embodiment, the system described herein monitors devices by building optimal models, namely a predictive model, a clustering model, and a statistical model. A TRUST-TECH enhanced neural network is developed for the optimal predictive model. A TRUST-TECH enhanced affinity propagation model is developed for the optimal clustering model. Furthermore, a TRUST-TECH enhanced probability density estimation model is developed for the optimal statistical model.

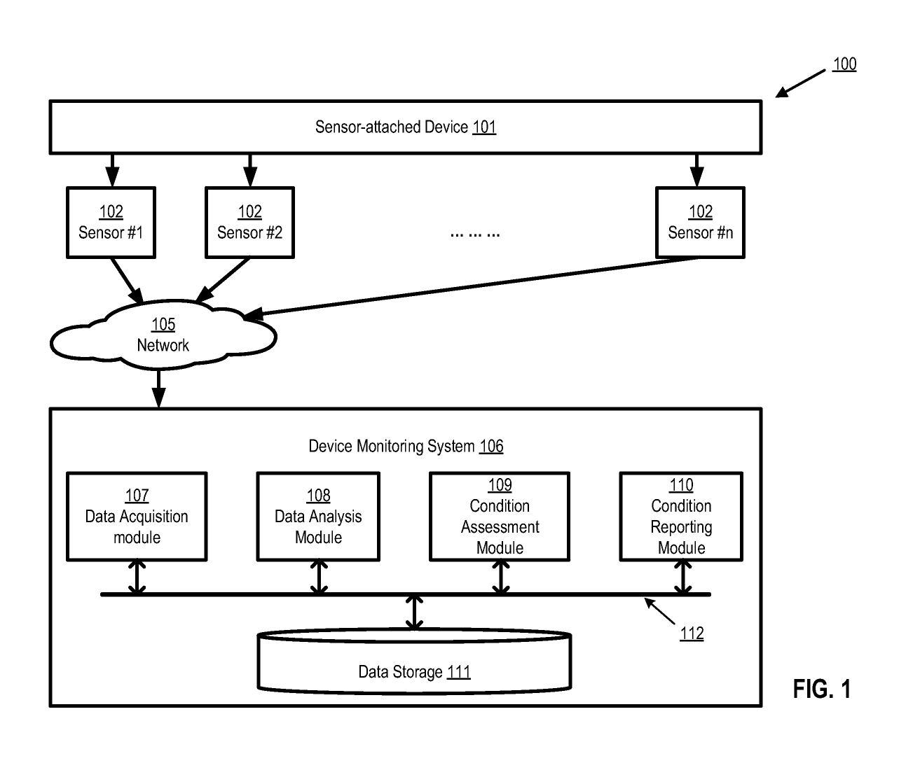

FIG. 1 illustrates a diagram of an overall architecture of a system 100 for detecting anomaly in a power system device according to one embodiment. The system 100 includes a power system device 101 whose condition is to be monitored. In one embodiment, the device 101 can be a power generator in a power plant. In another embodiment, the device 101 can be a wind turbine in a wind farm. In yet another embodiment, the device 101 can be an electrical transformer in a power grid. Attached to the device 101 is a plurality of sensors; namely, senor #1 102, sensor #2 103, . . . , and sensor #n 104. The term “attached sensors” refers to sensors connected to the device 101 by wired connections, wireless connections, or a combination of both. Each sensor constantly measures a quantity of the device and outputs the quantity as a time-stamped signal readable by programs encoded on computer storage media. In an embodiment where the device 101 is a wind turbine in a wind farm, one sensor measures the wind speed, another sensor measures the rotation speed of the turbine, yet another sensor measures the electrical power output by the turbine, and yet another sensor measures the temperature of the turbine. In another embodiment where the device 101 is an electrical transformer in a power grid, one sensor measures the voltage at a bushing, another sensor measures the load current through a bushing, yet another sensor measures the oil temperature in the tank, and yet another sensor measures the air temperature in the conservator. The time-stamped signals obtained by the plurality of sensors are transferred to a device monitoring system 106 via a communication network 105.

The time-stamped signals transferred to the device monitoring system 106 are collected by a data acquisition unit 107. The collected sensor signal data is transferred to a data storage 111 via a system data bus 112, and stored in the data storage 111. The data storage 111 can be any volatile or non-volatile memory device. Using the sensor signal data, a data analysis unit 108 performs data analysis by building and training a plurality of models on the aggregated data (i.e., historical sensor data) to model normal behaviors of the device 101. The data analysis unit 108 then applies multiple built and trained models on the target sensor data, which may be the most-recently acquired data, real-time sensor data (also referred to as online sensor data), or sensor data that is not part of the historical sensor data used for constructing the models. The condition of the device is computed by using the plurality of models. A condition assessment unit 109 assesses the condition of the device 101 by inspecting the computed anomaly score to determine if the score is within the normal range that indicates the device is under a normal condition, or is outside the normal range that indicates the device is under an abnormal condition. A condition reporting unit 110 reports the assessment to a system operator or other administrative entities. Abnormal behaviors detected in the target sensor data are warned, indicating abnormal behaviors of the device 101.

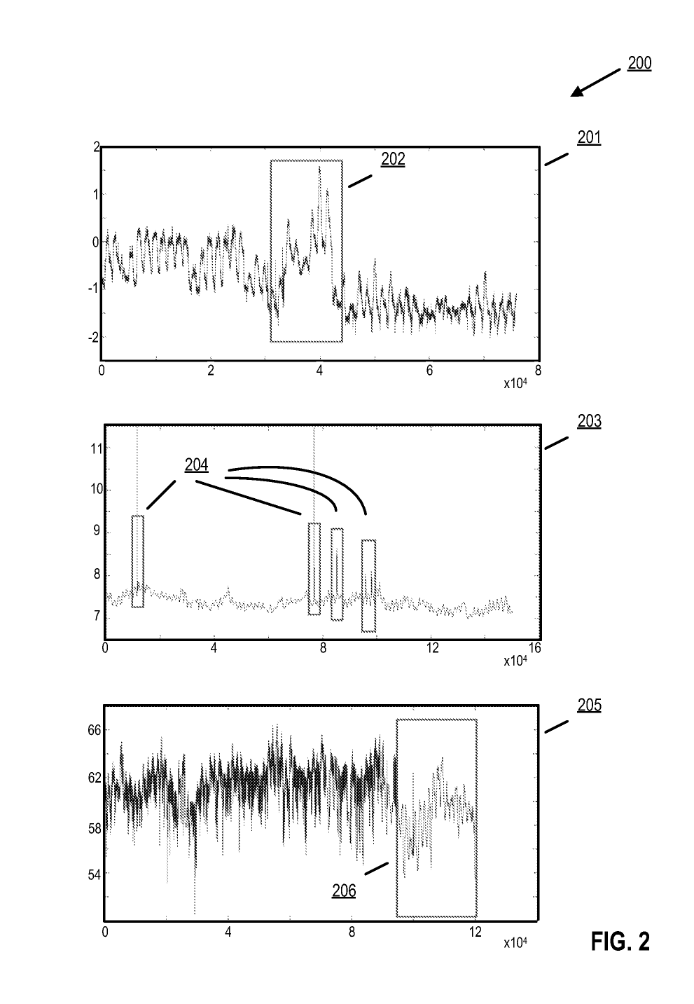

FIG. 2 is a signal waveform diagram 200 illustrating examples of sensor signals and identified anomalies in the signals. A time-stamped signal data 201, which is measured by one of the sensors 102 and acquired and stored by the device monitoring system 106, includes a data portion (enclosed by box 202) that is markedly different in signal magnitude from other portions of the data 201. The identified data portion indicates abnormal behaviors of the device 101. Another time-stamped signal data 203, which is measured by another one of the sensors 102 and acquired and stored by the device monitoring system 106, includes data portions (enclosed by boxes 204) that are markedly different in signal magnitude from other portions of the data 203. The identified data portions indicate abnormal behaviors of the device 101. Yet another time-stamped signal data 205, which is measured by yet another one of the sensors 102 and acquired and stored by the device monitoring system 106, includes a data portion (enclosed by boxes 206) that is markedly different in signal magnitude from other portions of the data 205.

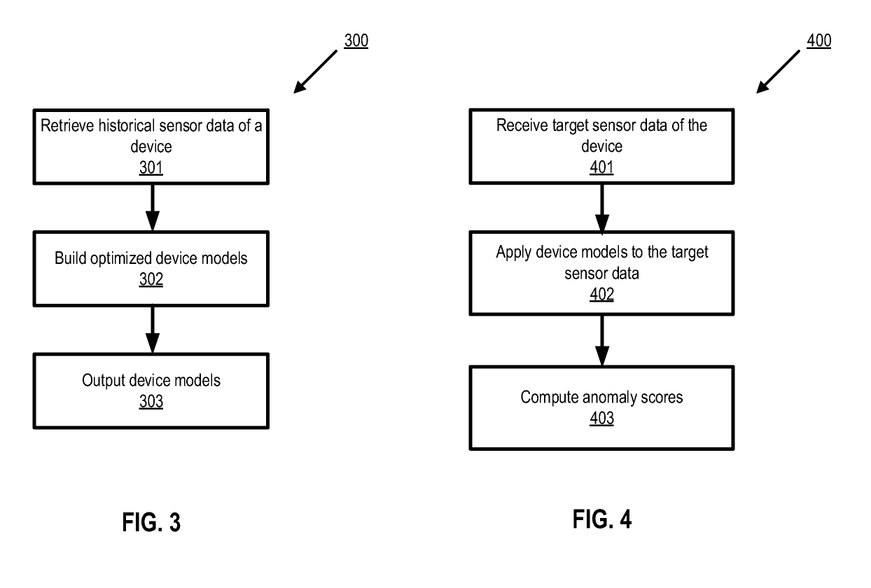

FIG. 3 is a flow diagram illustrating a method 300 of building and training models for detecting anomaly in power system devices according to one embodiment. In one embodiment, the method 300 may be performed by the data analysis unit 108 of FIG. 1. The data analysis unit 108 is configured to build and train a plurality of models to model normal behaviors of a power system device. The method 300 begins with the data analysis unit 108 receiving historical sensor data of a power system device (block 301) stored in the data storage 111. The historical sensor data is used for building one or more device models that model normal behaviors of the power system device (block 302). Some of the device models may also be trained.

In one embodiment, the problem of building and training the device models can be formulated as an optimization problem of the form:

$${min}_{x ∈ M} f ( x ) . \qquad ( 1 )$$

In one embodiment, the objective function f(x) for building a predictive model is the mean squared error (MSE) between the model outputs and the stored historical sensor data, the objective function f(x) for building a statistical model is the integrated squared error (ISE), and the objective function f(x) for building a clustering model is the within-cluster sum of differences (WCSD). Each of these objective functions f(x) can be nonlinear and nonconvex over a specified domain M, to which the values of x are confined, and can have multiple local optimal solutions. The optimization problem (1) is a global optimization problem for finding global optimal solution; namely, values of x which make f(x) be the smallest over the domain M. The model building and training therefore include optimizing objective functions by a global optimization engine.

The output of model building and training is a set of models (block 303) that models normal behaviors of the device. In one embodiment, the set of models include a predictive model, a statistical model, and a clustering model.

FIG. 4 is a flow diagram illustrating a method 400 for computing anomaly scores of target sensor data according to one embodiment. In this embodiment, the data analysis unit 108 is configured to execute a plurality of models to compute anomaly scores of the target sensor data. The method 400 begins with the data analysis unit 108 receiving target sensor data (block 401). The data analysis unit 108 applies one or more device models; e.g., the predictive model, the statistical model, and the clustering model to the target sensor data (block 402). The data analysis unit 108 then computes anomaly scores (block 403) on the target sensor data.

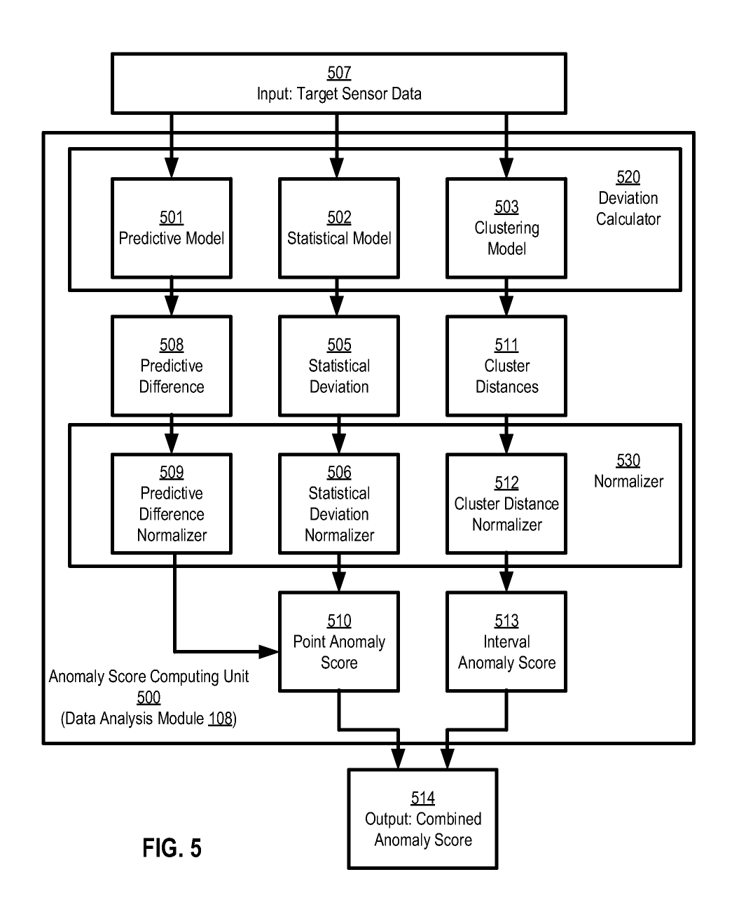

FIG. 5 is a diagram illustrating an anomaly score computing unit 500 according to one embodiment. In one embodiment, the anomaly score computing unit 500 is part of the data analysis unit 108 of FIG. 1. The anomaly score computing unit 500 includes a deviation calculator 520, which receives target sensor data 507 as input, applies data models to the input, and calculates the amount that the target sensor data 507 deviates from each of the data models. In one embodiment, the data models include a predictive model 501, a statistical model 502 and a clustering model 503. The deviation calculator 520 calculates the feature vectors of the target sensor data 507, and computes the difference between those feature vectors and the output of the predictive model 501. The difference, referred to as the predictive difference 508, is normalized by a normalizer 530, or more specifically, a predicative difference normalizer 509. The predicative difference normalizer 509 applies a transformation function to the predictive difference 508 and produces a normalized value between 0 and 1. The value 0 indicates the model output exactly matches the target sensor data 507, thus the device's behavior being normal. The larger the normalized value is, the higher level of anomaly there is in the target sensor data 507 and the device's behavior.

In one embodiment, the transformation function can be the arctangent function

$$T ( x ) = \frac{2}{π} arctan ( \vert x \vert ) . \qquad ( 2 )$$

In another embodiment of the invention, the transformation function can be the hyperbolic tangent sigmoid function

$$T ( x ) = \frac{1 - {e}^{\vert x \vert}}{1 + {e}^{\vert x \vert}} . \qquad ( 3 )$$

In yet another embodiment of the invention, the transformation function can be

$$T ( x ) = \frac{\vert x \vert}{\sqrt{( 1 + {x}^{2} )}} . \qquad ( 4 )$$

The deviation calculator 520 also calculates the amount that the target sensor data 507 deviates from the statistical model 502. The amount of deviation, referred to as the statistical deviation 505, is normalized by the normalizer 530, or more specifically, a statistical deviation normalizer 506. The statistical deviation normalizer 506 applies a transformation function to the statistical deviation 505 and produces a normalized value between 0 and 1. The value 0 indicates the model output exactly matches the target sensor data 507, thus the device's behavior being normal. The larger the normalized value is, the higher level of anomaly there is in the target sensor data 507 and the device's behavior. In one embodiment, the transformation function can be the arctangent function (2). In another embodiment, the transformation function can be the hyperbolic tangent sigmoid function (3). In yet another embodiment of the invention, the transformation function can be (4).

In one embodiment, the normalized predictive difference and the normalized statistical deviation are combined to generate a point anomaly score 510. In one embodiment, the point anomaly score 510 is the average of the normalized predictive difference and the normalized statistical deviation.

In one embodiment, the deviation calculator 520 further computes the difference between the target sensor data 507 and the output of the clustering model 503. The difference, referred to as the clustering difference 511, is the distances between the target sensor data 507 and the data clusters U₁, U₂, . . . , U_{K}, each of which contains a plurality of data points computed by the clustering model 503. In one embodiment, the distance is

$$D ( x , {U}_{i} ) = {min}_{y ∈ {U}_{i}} d ( x , y ) . \qquad ( 5 )$$

where Uᵢ is the i-th cluster, i=1,2, . . . , K, and d(·) is the distance between two vectors. In one embodiment, the distance can be

$$d ( x , y ) = {( {\sum }_{j = 1}^{n} {\vert {x}_{j} - {y}_{j} \vert}^{p} )}^{\frac{1}{p}} . \qquad ( 6 )$$

In another embodiment, the distance can be

$$d ( x , y ) = \frac{{\sum }_{j = 1}^{n} ( {x}_{j} - \overline{x} ) ( {y}_{j} - \overline{y} )}{\sqrt{{\sum }_{j = 1}^{n} {( {x}_{j} - \overline{x} )}^{2} {\sum }_{j = 1}^{n} {( {y}_{j} - \overline{y} )}^{2}}} , \qquad ( 7 )$$

where x̅ and y̅ are the mean value of the data vectors x and y, respectively.

The clustering difference normalizer 512 applies a transformation function on the ratio dₙ/dₐ between the distance dₙ to the normal cluster(s) and the distance dₐ to the abnormal cluster(s) and produces a value between 0 and 1. The value 0 indicates the model output exactly matches the target sensor data 507, thus the device's behavior being normal. The larger the normalized value is, the higher level of anomaly there is in the target sensor data 507 and the device's behavior.

The normalized value produced by the clustering difference normalizer 512 is also referred to as an interval anomaly score 513. In one embodiment, the point anomaly score 510 and the interval anomaly score 513 are combined to obtain the final anomaly score 514. In one embodiment, the combination can be realized as the average score of the point anomaly score 510 and the interval anomaly score 513. In another embodiment, the combination can be realized as the maximum score of the point anomaly score 510 and the interval anomaly score 513.

FIG. 6 is a block diagram of a model building unit 600 according to one embodiment. In one embodiment, the model building unit 600 is part of the data analysis unit 108 of FIG. 1. The model building unit 600 is configured to build and train multiple data models to model normal behaviors of a power system device. The model building unit 600 receive historical sensor data 601 retrieved from the data storage unit 111. For the predictive model 501, the model building unit 600 includes a neural network feature extraction unit 603 that performs feature extraction on the historical sensor data 601 to produce a set of feature vectors. The model building unit 600 further includes a neural network building unit 604 that uses the extracted feature vectors to build the predictive model 501.

The model building unit 600 further includes an auto regression learning unit 606 that uses the historical sensor data 601 to build the statistical model 502. The model building unit 600 further includes a clustering feature extraction unit 607 that performs feature extraction on the historical sensor data 601 to produce another set of feature vectors. The model building unit 600 further includes an affinity propagation clustering unit 608 that uses the extracted feature vectors to build the clustering model 503.

The problem of building device models can be formulated as an optimization problem (1). One reliable way of finding the global optimal solution for the optimization problem (1) is to find first all the local optimal solutions, and then find, from the local optimal solutions, the global optimal solution. In one embodiment, the global optimal solution can be found through a procedure that includes the following two steps:

Step 1: Start from an arbitrary point and compute a local optimal solution to the optimization problem (1).

Step 2: Move away from the local optimal solution and approach another local optimal solution of the optimization problem (1).

TRUST-TECH based methods realize these two steps using some trajectories of a particular class of nonlinear dynamical systems. More specifically, TRUST-TECH based methods accomplish this task by the following steps:

(i) Construct a dynamical system such that there is a one-to-one correspondence between the set of local optimal solutions to the optimization problem (1) and the set of stable equilibrium points (SEPs) of the dynamical system. In other words, for each local optimal solution to the problem (1), there is a distinct SEP of the dynamical system that corresponds to it.

(ii) Then the task of finding all local optimal solutions can be accomplished by finding all SEPs of the constructed dynamical system and finding a complete set of local optimal solutions to the problem (1) among the complete set of SEPs.

(iii) Find the global optimal solution from the complete set of local optimal solutions.

In the embodiment of FIG. 6, the model building unit 600 includes a TRUST-TECH optimization engine 609, which enables the model building unit 600 to build and train multiple device models to model normal behaviors of a power system device using TRUST-TECH based optimization methods.

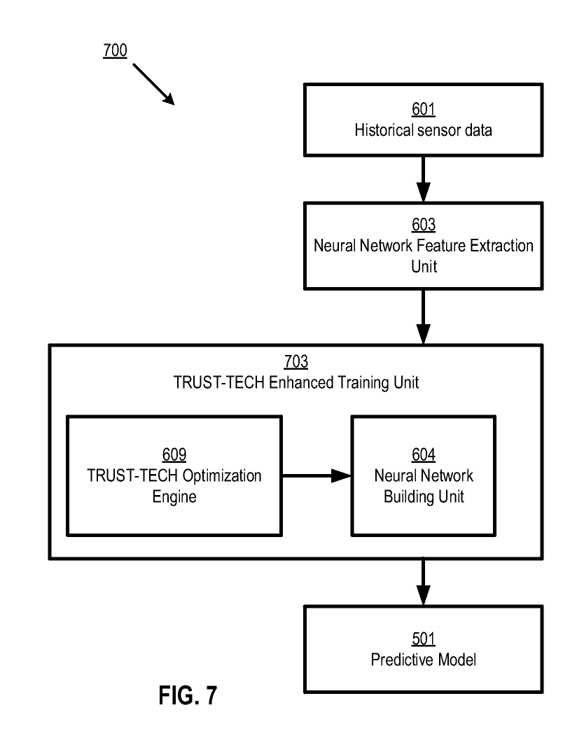

FIG. 7 is a diagram illustrating a module 700 for building and training neural network based predictive models according to one embodiment. The module 700 may be part of the model building unit 600 of FIG. 6. Referring also to FIG. 6, the module 700 includes the neural network feature extraction unit 603, which retrieves historical data 601 from the data storage 111 to perform feature extraction on the stored sensor data and to produce a first set of feature vectors, namely, a₁, . . . , a_{Q}. The module 700 also includes a TRUST-TECH enhanced training unit 703, which further includes the neural network building unit 604 and the TRUST-TECH optimization engine 609. The TRUST-TECH enhanced training unit 703 builds and trains the predictive model 501 (e.g., a neural network based predictive model) to model normal behaviors of the power system device using the first set of feature vectors.

The performance of a neural network is usually gauged by measuring the mean square error (MSE) of its output. The goal of optimal training is to find a set of parameters that achieves the global minimum MSE. The optimization problem (1) for optimal neural network model building can be formulated as minimizing the MSE over Q samples in the training set and is given by:

$${min}_{x ∈ {R}^{n}} f ( x ) = \frac{1}{Q} {\sum }_{i = 1}^{Q} {[ {t}_{i} - y ( {a}_{i} , x ) ]}^{2} . \qquad ( 8 )$$

where, tᵢ is the target output for the i-th feature vᵢ, x is the vector of weights of the neural network to be trained, and y(.) is the network output function. The MSE as a function of the network parameters usually contains multiple local optimal solutions.

The TRUST-TECH optimization engine 609 solves the optimization problem (8) by first constructing a dynamical system such that the SEPs in the dynamical system have one-to-one correspondence with local optimal solutions of the optimization problem (8). Because of such correspondence, the problem of computing multiple local optimal solutions of the optimization problem is then transformed to finding multiple stability regions in the defined dynamical system, each of which contains a distinct SEP. An SEP can be computed with the trajectory method or using a local method with a trajectory point in its stability region as the initial point. To solve the optimization problem (8), the desired dynamical system can be defined as a following negative gradient system:

$$\frac{d x}{d t} = - {grad}_{R} f ( x ) = - {R ( x )}^{- 1} \cdot ∇ f ( x ) . \qquad ( 9 )$$

where R(x) is a positive definite symmetric matrix (also known as the Riemannian metric).

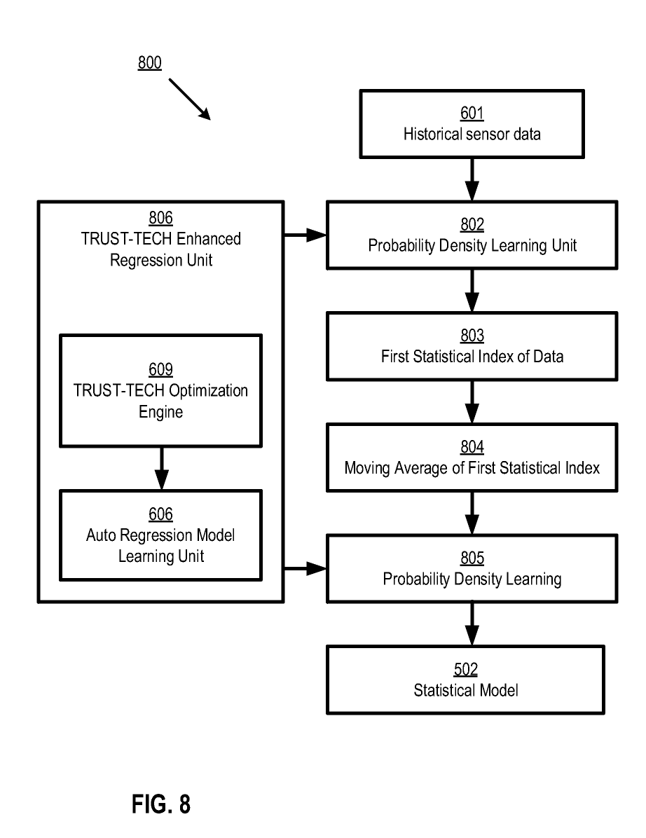

FIG. 8 is a diagram illustrating a module 800 for building and training auto-regression based statistical models according to one embodiment. The module 800 may be part of the model building unit 600 of FIG. 6. Referring also to FIG. 6, the module 800 includes a probability density learning unit 802 receiving the historical sensor data 601 stored in the data storage unit 111 to calculate a probability density of the historical sensor data 601:

$${p}_{t} = p ( {g}_{t} \vert {g}_{t - k}^{t - 1} \text{:} {x}_{1} ) = \frac{1}{\sqrt{2 π} {σ}_{1}} exp ( - \frac{{( {g}_{t} - {w}_{1} )}^{2}}{2 {σ}_{1}} ) \qquad ( 10 )$$

at time stamp t of the sensor data within a time window of size k, where w₁=Σᵢ₌₁^{k}a₁_{ᵢ}(gₜ₋ᵢ−μ₁) and x₁=(a₁₁, . . . , a₁ₖ, μ₁, σ₁)^{T}. The unit 800 further includes another unit 803 to calculate the first statistical index v₁(·) of data that is

v₁(gₜ)=−log pₜ₋₁(gₜ|g^{t-1}). (11)

The unit 800 includes yet another unit 804 to calculate the moving average of the first statistical index data through

$${h}_{t} = - \frac{1}{T} {Σ}_{i = t - T}^{t - 1} log {p}_{i} ( {g}_{i + 1} \vert {g}^{i} ) . \qquad ( 12 )$$

The unit 800 includes yet another probability density learning unit 805 receiving the moving average data 804 to calculate another probability density of the moving average data

$${q}_{t} = p ( {h}_{t} \vert {h}_{t - k}^{t - 1} \text{:} {x}_{2} ) = \frac{1}{\sqrt{2 π} {σ}_{2}} exp ( - \frac{{( {h}_{t} - {w}_{2} )}^{2}}{2 {σ}_{2}} ) \qquad ( 13 )$$

at time stamp t of the sensor data within a time window of size k, where w₂=Σᵢ₌₁^{k}a₂ᵢ(hₜ₋ᵢ−μ₂) and x₂=(a₂₁, . . . , a₂ₖ, μ₂, σ₂)^{T}.

The optimization problem (1) for optimal statistical model building, namely to compute the optimal vectors of parameter values x₁=(a₁₁, . . . , a₁ₖ, μ₁, σ₁)^{T} in (10), can be formulated as an optimization problem:

$${min}_{{x}_{1}} f ( {x}_{1} ) = - {{Σ}_{i}^{t} ( 1 - r )}^{t - i} log p ( {g}_{t} \vert {g}^{i - 1} , {x}_{1} ) . \qquad ( 14 )$$

Furthermore, the computation of the optimal vectors of parameter values x₂=(a₂₁, . . . , a₂ₖ, μ₂, σ₂)^{T} in (13) can be formulated as another optimization problem:

$${min}_{{x}_{2}} f ( {x}_{2} ) = - {{Σ}_{i}^{t} ( 1 - r )}^{t - i} log p ( {h}_{t} \vert {h}^{i - 1} , {x}_{2} ) . \qquad ( 15 )$$

The parameter estimation objective functions (14) and (15) as a functions of the statistical parameters, namely x₁=(a₁₁, . . . , a₁ₖ, μ₁, σ₁)^{T} for (14) and x₂=(a₂₁, . . . , a₂ₖ, μ₂, σ₂)^{T} for (15) are usually nonlinear and nonconvex, thus can contain many local optimal solutions.

The unit 800 includes a TRUST-TECH enhanced regression unit 806, comprising the affinity auto regression model learning unit 808 and the TRUST-TECH optimization unit 807 to compute optimal parameters for the probability densities (10) and (13) by solving the associated optimization problems (14) and (15). The probability density functions (10) and (13), defined by the computed optimal parameters x₁=(a₁₁, . . . , a₁ₖ, μ₁, σ₁)^{T} and x₂=(a₂₁, . . . , a₂ₖ, μ₂, σ₂)^{T}, respectively, constitute the statistical model 502 for modeling normal behaviors of a power system device.

The TRUST-TECH optimization unit 807 solves the optimization problems (14) and (15) by first constructing a dynamical system such that the SEPs in the dynamical system have one-to-one correspondence with local optimal solutions of the optimization problems (14) and (15). Because of such correspondence, the problem of computing multiple local optimal solutions of the optimization problem is then transformed to finding multiple stability regions in the defined dynamical system, each of which contains a distinct SEP. An SEP can be computed with the trajectory method or using a local method with a trajectory point in its stability region as the initial point. To solve the optimization problems (14) and (15), the desired dynamical system can be defined as the following negative gradient system:

$$\frac{d x}{d t} = - {grad}_{R} f ( x ) = - {R ( x )}^{- 1} \cdot ∇ f ( x ) , \qquad ( 16 )$$

where R(x) is a positive definite symmetric matrix (also known as the Riemannian metric).

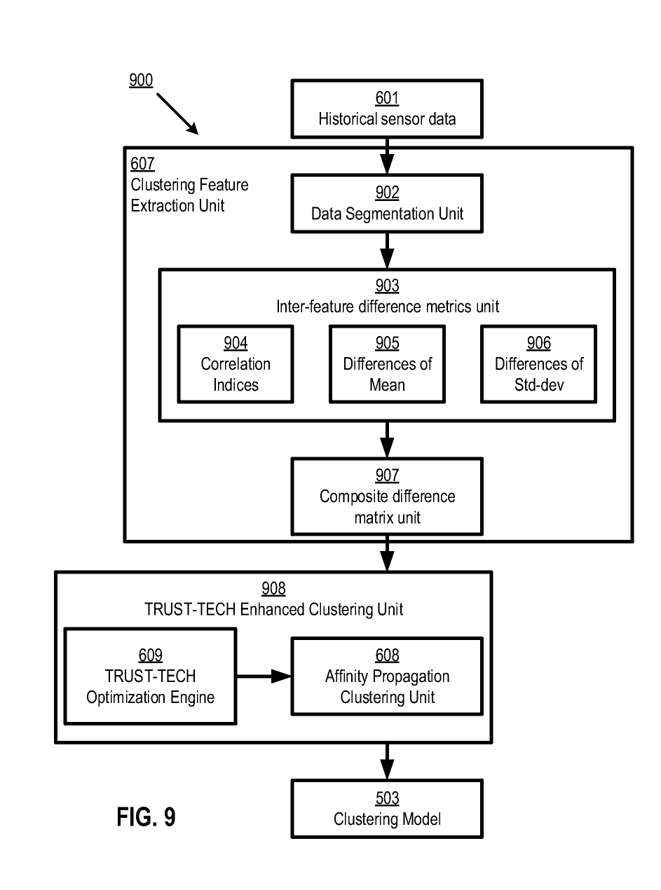

FIG. 9 is a diagram illustrating a module 900 for building and training affinity propagation based clustering models according to one embodiment. The module 900 may be part of the model building unit 600 of FIG. 6. Referring also to FIG. 6, the module 900 includes the clustering feature extraction unit 607 that further includes a data segmentation unit 902 to extract, from the stored historical sensor data 601, a plurality of feature vectors, namely, b₁, . . . , b_{N}, each of which belongs to Rⁿ. The clustering feature extraction unit 607 also includes an inter-feature difference metrics unit 903, which calculates a plurality of metrics to represent the difference between each pair of feature vectors. The inter-feature difference metrics unit 903 further includes a correlation index unit 904 calculating the correlation coefficient using the following formulation

$${c}_{ij} = \frac{{Σ}_{k = 1}^{n} ( {b}_{ik} - {\overline{b}}_{1} ) ( {b}_{jk} - {\overline{b}}_{j} )}{\sqrt{{{Σ}_{k = 1}^{n} ( {b}_{ik} - {\overline{b}}_{1} )}^{2} {{Σ}_{k = 1}^{n} ( {b}_{jk} - {\overline{b}}_{j} )}^{2}}} \qquad ( 17 )$$

between a pair of feature vectors bᵢ and bⱼ with i=1, . . . N and j=1, . . . , N, where

$${\overline{b}}_{i} = \frac{1}{n} {Σ}_{k = 1}^{n} {b}_{ik} and {\overline{b}}_{j} = \frac{1}{n} {Σ}_{k = 1}^{n} {b}_{jk}$$

are the mean values of bᵢ and bⱼ, respectively.

The inter-feature difference metrics unit 903 includes a differences of mean unit 905 calculating the difference

mᵢⱼ=|b̅ᵢ−b̅ⱼ| (18)

between the mean values of a pair of vectors bᵢ and bⱼ with i=1, . . . N and j=1, . . . , N.

The inter-feature difference metrics unit 903 includes a differences of standard deviation unit 906 calculating the difference

dᵢⱼ=|s̅ᵢ−s̅ⱼ| (19)

between the standard deviation values of a pair of vectors bᵢ and bⱼ with i=1, . . . N and j=1, . . . , N, where

$${\overline{s}}_{i} = \frac{1}{n - 1} {{Σ}_{k = 1}^{n} ( {b}_{ik} - {\overline{b}}_{i} )}^{2} and {\overline{s}}_{j} = \frac{1}{n - 1} {{Σ}_{k = 1}^{n} ( {b}_{jk} - {\overline{b}}_{j} )}^{2}$$

are the standard deviation values of bᵢ and bⱼ, respectively.

The module 900 includes a composite difference matrix unit 907 calculating the composite difference matrix

$$S = [ \begin{matrix}{s}_{11} & … & {s}_{1 N} \\ ⋮ & ⋱ & ⋮ \\ {s}_{N 1} & … & {s}_{NN}\end{matrix} ] , \qquad ( 20 )$$

where, sᵢⱼ=w₁cᵢⱼ+w₂mᵢⱼ+w₃dᵢⱼ with i=1, . . . N and j=1, . . . , N, and w₁, w₂ and w₃ are the weighting factors for the three difference metrics, respectively. This difference matrix provides the difference values between each pair of samples in the dataset.

The module 900 includes a TRUST-TECH enhanced clustering unit 908, which further includes the affinity propagation clustering unit 608 and the TRUST-TECH optimization engine 609. The TRUST-TECH enhanced clustering unit 908 receives the composite difference matrix 907, builds and trains the clustering model 503 (e.g., an affinity propagation based clustering model) to model normal behaviors of the device using the plurality of feature vectors extracted in the clustering feature extraction unit 607.

The performance of a clustering is usually gauged by measuring the within cluster sum of differences (WCSD) between the plurality of feature vectors and a plurality of center vectors. The goal of optimal clustering is to find an optimal number of center vectors and optimal values for each center vector that jointly achieves the global minimum WCSD. The optimization problem (1) for optimal clustering model building can be formulated as minimizing the WCSD over N samples in the training set and is given by:

$${min}_{{u}_{1} , … , {u}_{K} ∈ {R}^{n} , K ∈ N} f ( {u}_{1} , … {u}_{K} , K ) = {Σ}_{i}^{K} {Σ}_{u ∈ {U}_{i}} {s}_{{vu}_{i}} . \qquad ( 21 )$$

where, x=(u₁, . . . u_{K}, K)^{T} is the vector of optimization variables, K is the number of clusters U₁, . . . , U_{K} are the clusters with cluster center vectors u₁, . . . , u_{K}, respectively, and sᵥᵤ_{ᵢ} is the difference between the feature vector v and the cluster center uᵢ, which is also a feature vector. Since both v and uᵢ, i=1, . . . , K, are feature vectors extracted, the difference value sᵥᵤ_{ᵢ} is recorded in the composite difference matrix S and is readily available. The WCSD as a function of the clustering parameters, namely, the number of clusters K and the center feature vectors u₁, . . . , u_{K}, usually contains many local optimal solutions.

The TRUST-TECH optimization unit 609 solves the optimization problem (21) by first constructing a dynamical system such that the stable equilibrium points (SEPs) in the dynamical system have one-to-one correspondence with local optimal solutions of the optimization problem (21). Because of such correspondence, the problem of computing multiple local optimal solutions of the optimization problem is then transformed to finding multiple stability regions in the dynamical system, each of which contains a distinct SEP. An SEP can be computed with a trajectory method, such as the backward Euler method, the forward Euler method, the Trapezoidal method and the Runge-Kutta methods, or using a local method, such as the Newton's method, the trust-region method, the sequential quadratic programming (SQP) and the interior point method (IPM), with a trajectory point in its stability region as the initial point. To solve the optimization problem (21), the desired dynamical system can be defined as the following negative gradient system:

$$\frac{d x}{d t} = - {grad}_{R} f ( x ) = - {R ( x )}^{- 1} \cdot ∇ f ( x ) . \qquad ( 22 )$$

where R(x) is a positive definite symmetric matrix (also known as the Riemannian metric).

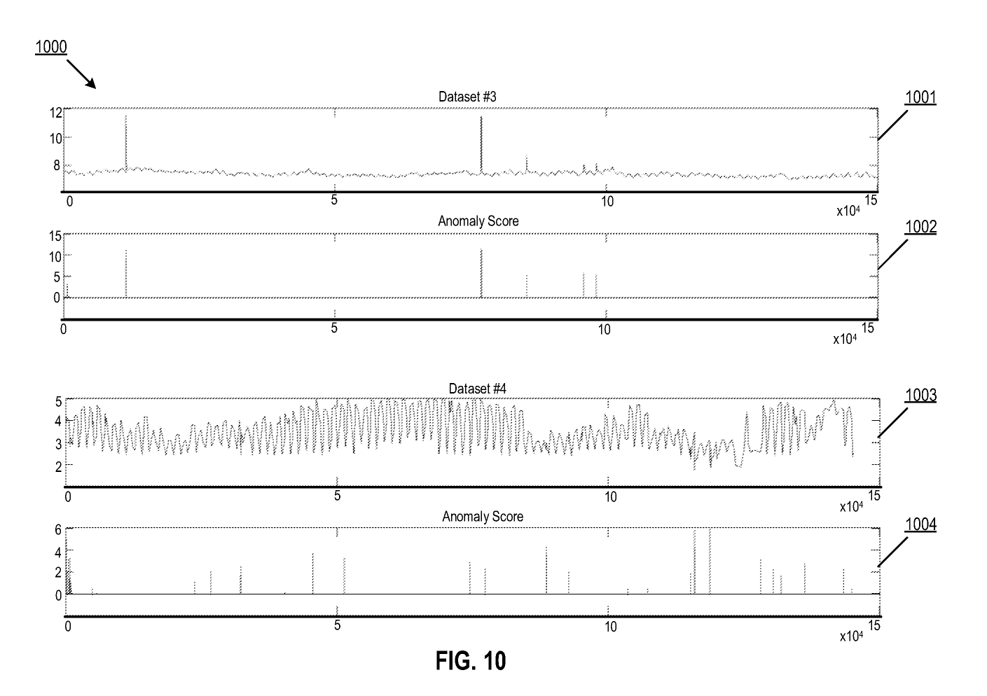

FIG. 10 is a signal waveform diagram 1000 illustrating examples of sensor signals and anomalies in the signals detected by the device monitoring system 106 of FIG. 1. A time-stamped signal data 1001 measured by a sensor and acquired and stored by the system 106 contains abnormal patterns, namely the signal magnitudes, which are markedly different from other portions of the signal, indicating abnormal behaviors of the device 101. Another time-stamped data 1002 with the same time stamps as the time-stamped signal data 1001, where positions of the anomalies detected by the system 106 are assigned with values larger than zero, and the magnitudes of the assigned values at the anomalous positions indicate the level of the anomaly. The positions of normal parts are assigned with value zero. Yet another time-stamped signal data 1003 measured by another sensor and acquired and stored by the system 106 contains abnormal patterns, namely the signal magnitudes, which are markedly different from other portions of the signal, indicating abnormal behaviors of the device 101. Yet another time-stamped data 1004 produced by the system 106, with the same time stamps as the time-stamped signal data 1003, where positions of the anomalies detected by the system 106 are assigned with values larger than zero, and the magnitude of the assigned values at the anomalous positions indicate the level of the anomaly. The positions of normal parts are assigned with value zero.

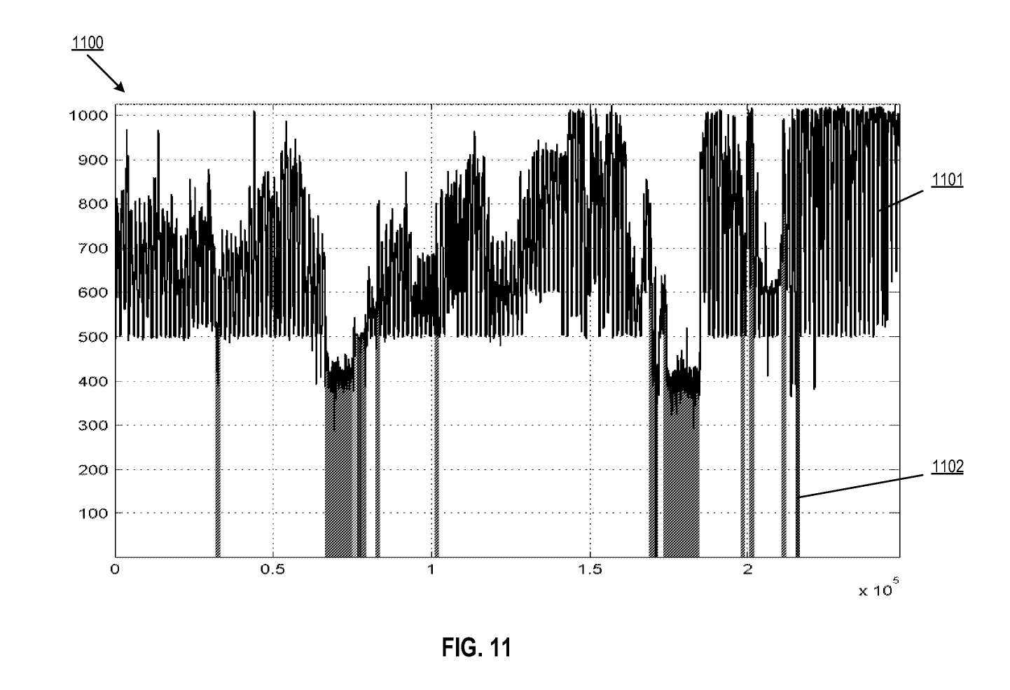

FIG. 11 is a signal waveform diagram 1100 illustrating another examples of sensor signals and anomalies in the signals detected by the device monitoring system 106 of FIG. 1. A time-stamped signal data 1101 measured by yet another sensor and acquired and stored by the system 106 contains intervals of abnormal patterns, namely the signal magnitude and the change of the magnitude in the intervals, which are markedly different to other portions of the signal, indicating abnormal behaviors of the device 101. Yet another time-stamped data 1102 produced by the system 106 with the same time stamps as the time-stamped signal data 1101, where positions of the anomalies detected by the system 106 are assigned with values larger than zero, and the magnitudes of the assigned values at the anomalous positions indicate the level of the anomaly. The positions of normal parts are assigned with value zero.

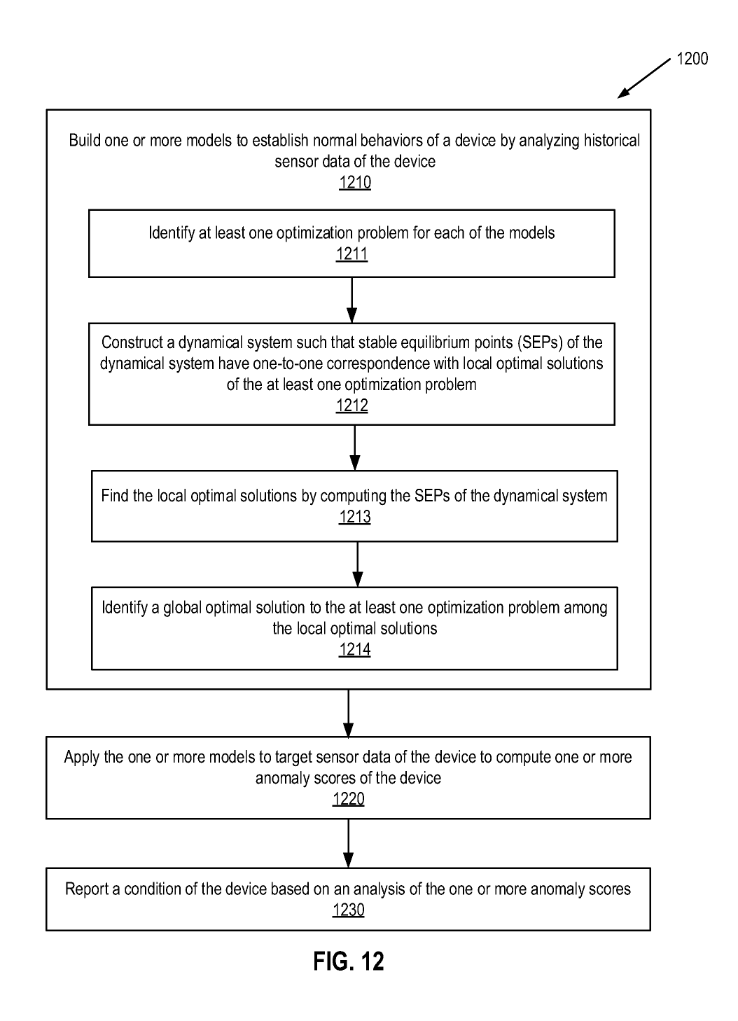

FIG. 12 is a flow diagram illustrating an embodiment of a method 1200 performed by the data monitoring system 106 of FIG. 1 for detecting an anomaly condition of a device having attached sensors. The method 1200 begins with the system 106 building one or more models to establish normal behaviors of the device by analyzing historical sensor data of the device (block 1210). The step of building the one or more models further comprises: identifying at least one optimization problem for each of the models (block 1211); constructing a dynamical system such that SEPs of the dynamical system have one-to-one correspondence with local optimal solutions of the at least one optimization problem (block 1212); finding the local optimal solutions by computing the SEPs of the dynamical system (block 1213); and identifying a global optimal solution to the at least one optimization problem among the local optimal solutions (block 1214). The method 1200 continues as the system 106 applying the one or more models to target sensor data of the device to compute one or more anomaly scores of the device (block 1220); and reporting a condition of the device based on an analysis of the one or more anomaly scores (block 1230).

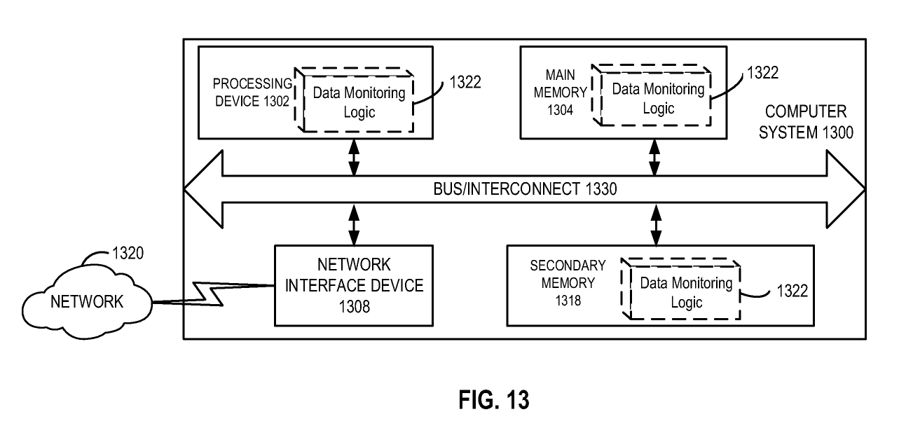

While the method 1200 of FIG. 12 shows a particular order of operations performed by certain embodiments of the invention, it should be understood that such order is exemplary (e.g., alternative embodiments may perform the operations in a different order, combine certain operations, overlap certain operations, etc.). One or more parts of an embodiment of the invention may be implemented using different combinations of software, firmware, and/or hardware. In one embodiment, the methods described herein may be performed by a processing system. One example of a processing system is a computer system 1300 of FIG. 13.

Referring to FIG. 13, the computer system 1300 may be a server computer, or any machine capable of executing a set of instructions (sequential or otherwise) that specify actions to be taken by that machine. While only a single machine is illustrated, the term “machine” shall also be taken to include any collection of machines (e.g., computers) that individually or jointly execute a set (or multiple sets) of instructions to perform any one or more of the methodologies discussed herein.

The computer system 1300 includes a processing device 1302. The processing device 1302 represents one or more general-purpose processors, or one or more special-purpose processors, or any combination of general-purpose and special-purpose processors. In one embodiment, the processing device 1302 is adapted to execute the operations of the data monitoring system 106 of FIG. 1, which performs the methods described in connection with FIGS. 3, 4 and 12 for anomaly detection.

In one embodiment, the processor device 1302 is coupled, via one or more buses or interconnects 1330, to one or more memory devices such as: a main memory 1304 (e.g., read-only memory (ROM), flash memory, dynamic random access memory (DRAM), a secondary memory 1318 (e.g., a magnetic data storage device, an optical magnetic data storage device, etc.), and other forms of computer-readable media, which communicate with each other via a bus or interconnect. The memory devices may also different forms of read-only memories (ROMs), different forms of random access memories (RAMs), static random access memory (SRAM), or any type of media suitable for storing electronic instructions. In one embodiment, the memory devices may store the code and data of the data monitoring system 106, which may be stored in one or more of the locations shown as dotted boxes and labeled as data monitoring logic 1322.

The computer system 1300 may further include a network interface device 1308. A part or all of the data and code of the data monitoring system 106 may be transmitted or received over a network 1320 via the network interface device 1308. Although not shown in FIG. 13, the computer system 1300 also may include user input/output devices (e.g., a keyboard, a touch screen, speakers, and/or a display).

In one embodiment, the computer system 1300 may store and transmit (internally and/or with other electronic devices over a network) code (composed of software instructions) and data using computer-readable media, such as non-transitory tangible computer-readable media (e.g., computer-readable storage media such as magnetic disks; optical disks; read only memory; flash memory devices) and transitory computer-readable transmission media (e.g., electrical, optical, acoustical or other form of propagated signals—such as carrier waves, infrared signals).

In one embodiment, a non-transitory computer-readable medium stores thereon instructions that, when executed on one or more processors of the computer system 1300, cause the computer system 1300 to perform the method 1200 of FIG. 12.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A computer-implemented method for detecting an anomaly condition of a device having attached sensors, the method comprising:
building one or more models to establish normal behaviors of the device by analyzing historical sensor data of the device;
applying the one or more models to target sensor data of the device to compute one or more anomaly scores of the device; and
reporting a condition of the device based on an analysis of the one or more anomaly scores,
wherein building the one or more models further comprises:
identifying at least one optimization problem for each of the models;
constructing a dynamical system such that stable equilibrium points (SEPs) of the dynamical system have one-to-one correspondence with local optimal solutions of the at least one optimization problem;
finding the local optimal solutions by computing the SEPs of the dynamical system; and
identifying a global optimal solution to the at least one optimization problem among the local optimal solutions.

2. The method of claim 1, wherein the device is a power system device.

3. The method of claim 1, wherein the one or more models include a predictive model, a statistical model and a clustering model.

4. The method of claim 1, wherein the one or more models include a TRUST-TECH enhanced neural network model, a TRUST-TECH enhanced statistical model and a TRUST-TECH enhanced clustering model.

5. The method of claim 1, wherein the dynamical system is constructed as a negative gradient system formulated as:
$$\frac{d x}{d t} = - {grad}_{R} f ( x ) = - {R ( x )}^{- 1} \cdot ∇ f ( x ) ,$$
where f(x) is the at least one optimization problem and R(x) is a positive definite symmetric matrix.

6. The method of claim 1, wherein building the one or more models further comprises:
extracting Q feature vectors from the historical sensor data; and
building a neural network based predictive model for the device by minimizing a mean square error (MSE) of network parameters over Q samples in a training set.

7. The method of claim 1, wherein building the one or more models further comprises:
calculating a first probability density function of the historical data;
calculating a moving average of statistical index of data;
calculating a second probability density function of the moving average; and
building an auto-regression based statistical model for the device by optimizing vectors of parameter values for the first probability density function and the second probability density function.

8. The method of claim 1, wherein building the one or more models further comprises:
extracting N feature vectors from the historical sensor data;
calculating a plurality of metrics to represent similarities between each pair of the N feature vectors; and
building an affinity propagation based clustering model for the device by minimizing a within cluster sum of differences (WCSD) between the feature vectors and center vectors over N samples in a training set.

9. The method of claim 8, wherein calculating the plurality of metrics further comprises:
calculating a correlation between each pair of the N feature vectors;
calculating a first difference between mean values of each pair of the N feature vectors;
calculating a second difference between standard deviations of each pair of the N feature vectors; and
calculating a composite difference matrix based on the correlation, the first difference and the second difference.

10. The method of claim 1, wherein computing one or more anomaly scores further comprises:
computing an average of a normalized predictive difference based on a predictive model and a normalized statistical deviation based on a statistical model to obtain a point anomaly score;
computing an interval anomaly score based on a clustering model; and
combining the point anomaly score with the interval anomaly score to obtain a final anomaly score.

11. A system adapted to detect an anomaly condition of a device having attached sensors, the system comprising:
data storage to store historical sensor data of the device; and
a data analysis module coupled to the data storage, the data analysis module adapted to build one or more models to establish normal behaviors of the device by analyzing the historical sensor data, and apply the one or more models to target sensor data of the device to compute one or more anomaly scores of the device; and
a condition reporting module coupled to the data storage and adapted to report a condition of the device based on an analysis of the one or more anomaly scores, wherein the data analysis module further comprises a model building unit adapted to:
identify at least one optimization problem for each of the models;
construct a dynamical system such that stable equilibrium points (SEPs) of the dynamical system have one-to-one correspondence with local optimal solutions of the at least one optimization problem;
find the local optimal solutions by computing the SEPs of the dynamical system; and
identify a global optimal solution to the at least one optimization problem among the local optimal solutions.

12. The system of claim 11, wherein the device is a power system device.

13. The system of claim 11, wherein the one or more models include a predictive model, a statistical model and a clustering model.

14. The system of claim 11, wherein the one or more models include a TRUST-TECH enhanced neural network model, a TRUST-TECH enhanced statistical model and a TRUST-TECH enhanced clustering model.

15. The system of claim 11, wherein the dynamical system is constructed as a negative gradient system formulated as:
$$\frac{d x}{d t} = - {grad}_{R} f ( x ) = - {R ( x )}^{- 1} \cdot ∇ f ( x ) ,$$
where f(x) is the at least one optimization problem and R(x) is a positive definite symmetric matrix.

16. The system of claim 11, wherein the model building unit is further adapted to:
extract Q feature vectors from the historical sensor data; and
build a neural network based predictive model for the device by minimizing a mean square error (MSE) of network parameters over Q samples in a training set.

17. The system of claim 11, wherein the model building unit is further adapted to:
calculate a first probability density function of the historical data;
calculate a moving average of statistical index of data;
calculate a second probability density function of the moving average; and
build an auto-regression based statistical model for the device by optimizing vectors of parameter values for the first probability density function and the second probability density function.

18. The system of claim 11, wherein the model building unit is further adapted to:
extract N feature vectors from the historical sensor data;
calculate a plurality of metrics to represent similarities between each pair of the N feature vectors; and
build an affinity propagation based clustering model for the device by minimizing a within cluster sum of differences (WCSD) between the feature vectors and center vectors over N samples in a training set.

19. The system of claim 11, wherein the data analysis module is further adapted to:
compute an average of a normalized predictive difference based on a predictive model and a normalized statistical deviation based on a statistical model to obtain a point anomaly score;
compute an interval anomaly score based on a clustering model; and
combine the point anomaly score with the interval anomaly score to obtain a final anomaly score.

20. A non-transitory computer readable storage medium including instructions that, when executed by a computing system, cause the computing system to perform a method for detecting an anomaly condition of a device having attached sensors, the method comprising:
building one or more models to establish normal behaviors of the device by analyzing historical sensor data of the device;
applying the one or more models to target sensor data of the device to compute one or more anomaly scores of the device; and
reporting a condition of the device based on an analysis of the one or more anomaly scores,
wherein building the one or more models further comprises:
identifying at least one optimization problem for each of the models;
constructing a dynamical system such that stable equilibrium points (SEPs) of the dynamical system have one-to-one correspondence with local optimal solutions of the at least one optimization problem;
finding the local optimal solutions by computing the SEPs of the dynamical system; and
identifying a global optimal solution to the at least one optimization problem among the local optimal solutions.
